(19) United States
(12) Patent Application Publication
(10) Pub. No.: US 2026/0104663 A1
(43) Pub. Date: Apr. 16, 2026

(54) REMOVABLE UNIT, FIXING DEVICE, AND IMAGE FORMING APPARATUS

(71) Applicant: Takahiro IMADA, Kanagawa (JP)

(72) Inventor: Takahiro IMADA, Kanagawa (JP)

(21) Appl. No.: 19/292,906

(22) Filed: Aug. 7, 2025

(30) Foreign Application Priority Data
Oct. 16, 2024 (JP) 2024-180596

(51) Int. Cl. G03G 15/20; G03G 21/16; G03G 21/20

(52) U.S. Cl. CPC G03G 15/2028; G03G 15/2064; G03G 21/1647; G03G 21/206; G03G 2215/2003; G03G 2221/1639

(57) ABSTRACT

A removable unit includes a heater, an exterior housing and a grip. The exterior housing is made of metal and houses the heater. The grip is made of a material having a lower thermal conductivity than the metal. The grip is exposed on a part of an outer face of the exterior housing.

### CROSS-REFERENCE TO RELATED APPLICATIONS

This patent application is based on and claims priority pursuant to 35 U.S.C. § 119(a) to Japanese Patent Application No. 2024-180596, filed on Oct. 16, 2024, in the Japan Patent Office, the entire disclosure of which is hereby incorporated by reference herein.

### BACKGROUND

### Technical Field

The present disclosure relates to a removable unit such as a fixing device detachably installed in an apparatus such as an image forming apparatus and an image forming apparatus such as a copier, a printer, a facsimile, or a multifunction peripheral (MFP) having at least two functions of copying, printing, and facsimile transmission, including the removable unit.

### Related Art

An apparatus such as an image forming apparatus including a copier or a printer includes a removable unit that is detachably attached to an apparatus body, such as a fixing device or a sheet conveying device. The removable unit includes a handle (a grip). A user or a service person grips the handle to take out the removable unit from the apparatus body or attach the removable unit to the apparatus body to perform maintenance or replacement of the removable unit.

### SUMMARY

The present disclosure described herein provides the removable unit including a heater, an exterior housing, and a grip. The exterior housing is made of metal and houses the heater. The grip is made of a material having a lower thermal conductivity than the metal. The grip is exposed on a part of an outer face of the exterior housing.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus;

FIGS. 2A and 2B are perspective views of the image forming apparatus of FIG. 1 to illustrate a procedure of opening a cover.

FIG. 3 is a diagram illustrating a configuration of a fixing device;

FIG. 4 is a schematic cross-sectional view of the fixing device of FIG. 3 to illustrate parts extending in a width direction;

FIG. 5 is a schematic cross-sectional view of a fixing belt and flanges of the fixing device of FIG. 4 in a cross-section perpendicular to the surface of the paper on which FIG. 4 is drawn;

FIG. 6A is a perspective view of the fixing device of FIG. 3 viewed from above;

FIG. 6B is a perspective view of the fixing device of FIG. 3 viewed from below;

FIG. 7A is a top view of the fixing device of FIG. 6A;

FIG. 7B is a bottom view of the fixing device of FIG. 6B;

FIG. 8 is a schematic view of the fixing device of FIGS. 7A and 7B to illustrate the fixing device is gripped;

FIGS. 9A and 9B are side views of fixing devices;

FIG. 10A is a top view of a fixing device according to a modification; and

FIG. 10B is a bottom view of the fixing device of FIG. 10A.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

With reference to the drawings, descriptions are given below of embodiments of the present disclosure. In the drawings illustrating the following embodiments, like reference signs are allocated to elements having the same function or shape and redundant descriptions thereof are omitted below.

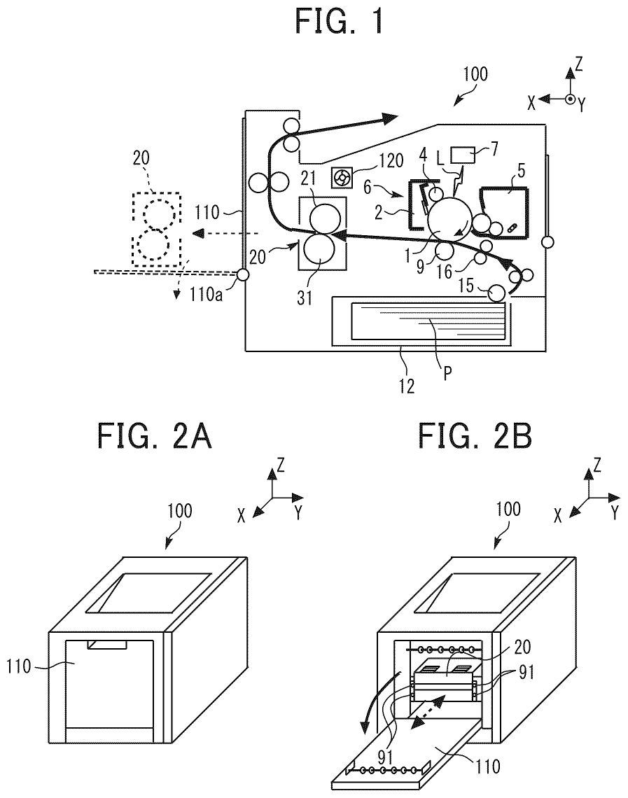

With reference to FIG. 1, the configuration and operation of an image forming apparatus 100 according to an embodiment including an apparatus body are described below.

In FIG. 1, the image forming apparatus 100 such as a small printer includes a process cartridge 6, an exposure device 7, a transfer roller 9, a sheet feeder 12, a registration roller pair 16 as a timing roller pair, a fixing device 20, and a fan 120. The process cartridge 6 is configured as a unit including a photoconductor drum 1, a charging roller 4, a developing device 5, and a cleaning device 2. The exposure device 7 irradiates the photoconductor drum 1 with exposure light L that is generated based on image data input from an input device such as a personal computer. A toner image is formed on the photoconductor drum 1. The sheet feeder 12 includes a feed tray to store sheets P. The registration roller pair 16 conveys a sheet P toward a transfer nip where the photoconductor drum 1 and the transfer roller 9 contact each other. The transfer roller 9 transfers the toner image borne on the photoconductor drum 1 onto the sheet P conveyed to the transfer nip (that is, a transfer position). The fixing device 20 fixes the toner image that has not yet been fixed, to the sheet P. The fixing device is configured to be the removable unit that is detachably attached to the apparatus body. The fan 120 generates an air flow flowing through a space above the fixing device 20.

The charging roller 4, the developing device 5, and the cleaning device 2 are arranged around the photoconductor drum 1. These members (the photoconductor drum 1, the charging roller 4, the developing device 5, and the cleaning device 2) are integrated as the process cartridge 6 and are detachably (replaceably) attached to the body of the image forming apparatus 100 as the apparatus body. After a user uses the process cartridge 6 for a predetermined replacement cycle, the user removes the process cartridge 6 from the body of the image forming apparatus 100 and replaces the process cartridge 6 with a new one.

The fixing device 20 is detachably attached to the body of the image forming apparatus 100 that serves as the apparatus body so that a service person can replace the fixing device 20 with a new one or perform the maintenance of the fixing device 20.

The image forming apparatus 100 according to the present embodiment is a small printer and is not typically designed so that the user accesses the inside of the image forming apparatus 100 to perform work except for replacement of the process cartridge 6 and jam processing (that is work to remove a sheet P that has stopped conveyance). The life of the fixing device 20 is set to be substantially the same as the life of the image forming apparatus 100. As a result, operations to detach the fixing device 20 from the body of the image forming apparatus 100 (the apparatus body) and attach the fixing device 20 to the apparatus body are limited to maintenance operations performed by the service person such as replacing the fixing device 20 with a new one when the fixing device 20 is broken. It is not assumed that the user detaches the fixing device 20 from the apparatus body and attaches the fixing device 20 to the apparatus body.

As illustrated in FIGS. 1, 2A, and 2B, the image forming apparatus 100 includes a cover 110 pivotable about a shaft 110a. The service person opens the cover 110 to detach the fixing device 20 as the removable unit from the body of the image forming apparatus 100 as the apparatus body and attach the fixing device 20 to the body of the image forming apparatus 100.

With reference to FIG. 1, typical processes of the image forming apparatus 100 are described below.

The input device such as the personal computer sends the image data to the exposure device 7 in the image forming apparatus 100, and the exposure device 7 irradiates the surface of the photoconductor drum 1 with the exposure light (a laser beam) L based on the image data.

A drive motor disposed in the body of the image forming apparatus 100 rotates the photoconductor drum 1 in the direction indicated by the arrow in FIG. 1 (clockwise). Initially, the charging roller 4 uniformly charges the surface of the photoconductor drum 1 at a position at which the surface of the photoconductor drum 1 faces the charging roller 4, which is called a charging process. As a result, a charging potential (for example, approximately −900 V) is formed on the surface of the photoconductor drum 1. Subsequently, the charged surface of the photoconductor drum 1 reaches an irradiation position of the exposure light L. An electric potential at the position that receives the exposure light L changes to a latent image potential (about 0 to −100 V), and an electrostatic latent image is formed on the surface of the photoconductor drum 1, which is called an exposure process.

After the exposure process, the surface of the photoconductor drum 1 on which the electrostatic latent image is formed reaches the position facing the developing device 5. The developing device 5 supplies toner onto the photoconductor drum 1 to develop the electrostatic latent image on the photoconductor drum 1 into a toner image, which is called a developing process.

After the developing process, the surface of the photoconductor drum 1 bearing the toner image reaches a transfer nip (that is, a transfer position) formed between the photoconductor drum 1 and the transfer roller 9. In the transfer nip, a transfer bias having a polarity opposite the polarity of the toner is applied from a power source to the transfer roller 9, thereby transferring the toner image formed on the photoconductor drum 1 onto the sheet P conveyed by the registration roller pair 16, which is called a transfer process.

The surface of the photoconductor drum 1 after the transfer process reaches a position opposite the cleaning device 2. At the position opposite the cleaner 2, a cleaning blade mechanically removes untransferred toner remaining on the surface of the photoconductor drum 1, and removed toner is collected in the cleaner 2, which is called a cleaning process.

Thus, a series of image forming processes on the photoconductor drum 1 is completed.

The sheet P is conveyed to the transfer nip between the photoconductor drum 1 and the transfer roller 9 as follows.

First, a feed roller 15 feeds the uppermost sheet P of the stack of sheets P stored in the sheet feeder 12 toward a conveyance passage.

Subsequently, the sheet P reaches the registration roller pair 16. The sheet P that has reached the registration roller pair 16 is conveyed to the transfer nip (the contact position of the transfer roller 9 with the photoconductor drum 1) in synchronization with an entry of the toner image formed on the photoconductor drum 1 into the transfer nip.

After the sheet P passes through the transfer nip (i.e., the position of the transfer roller 9) in the transfer process, the sheet P reaches the fixing device 20 through the conveyance passage. In the fixing device 20, the sheet P is interposed between a fixing belt 21 and a pressure roller 31. The toner image is fixed on the sheet P by heat applied from the fixing belt 21 and pressure applied from both the fixing belt 21 and the pressure roller 31. After the sheet P having the fixed toner image thereon is ejected from the fixing nip formed between the fixing belt 21 and the pressure roller 31, the sheet P is ejected from the body of the image forming apparatus 100 and stacked on an output tray.

Thus, a series of the image forming processes is completed.

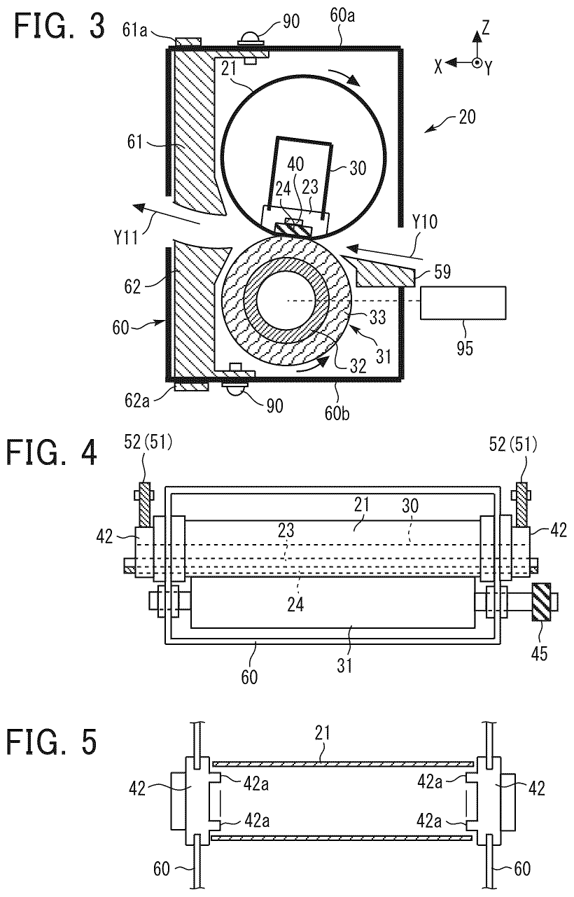

With reference to FIGS. 3 to 5, the following describes a configuration and operation of the fixing device 20 as the removable unit removably attached to the apparatus body of the image forming apparatus 1.

The fixing device 20 conveys the sheet P (bearing an unfixed toner image) while heating the sheet P. With reference to FIG. 3, the fixing device 20 includes the fixing belt 21 as a fixing rotator, a planar heater 24 as a heating unit (a heat source), a holder 23, a stay 30, a thermistor 40, the pressure roller 31 as a pressure rotator, an entrance guide plate 59, a fixing-side conveyance guide 61 (in other words, an upper exit guide), a pressure-side conveyance guide 62 (in other words, a lower exit guide), and an exterior housing frame 60 functioning as an exterior and a housing.

The fixing belt 21 as the fixing rotator is an endless belt disposed in contact with the outer circumferential surface of the pressure roller 31 and driven to rotate by rotation of the pressure roller 31. The fixing belt 21 is a thin, flexible endless belt driven to rotate clockwise in FIG. 3, that is, in a rotation direction indicated by an arrow in FIG. 3. The fixing belt 21 includes a base layer having an inner circumferential surface (i.e., a sliding contact surface of the fixing belt 21 sliding over the planar heater 24), an elastic layer coating the base layer, and a release layer coating the elastic layer, which define a total thickness of the fixing belt 21 not greater than 1 mm.

The base layer of the fixing belt 21 has a thickness in a range of from 30 μm to 50 μm and is made of metal, such as nickel or stainless steel, or resin such as polyimide.

The elastic layer of the fixing belt 21 has a thickness of 100 μm to 300 μm and is made of rubber such as silicone rubber, silicone rubber foam, or fluororubber. The elastic layer absorbs slight surface asperities of the fixing belt 21 at a fixing nip formed between the fixing belt 21 and the pressure roller 31, facilitating even heat conduction from the fixing belt 21 to the toner image on the sheet P and thereby preventing formation of an orange peel image on the sheet P.

The release layer of the fixing belt 21 has a thickness in a range of from 5 μm to 50 μm and is made of a material such as tetrafluoroethylene-perfluoroalkyl vinyl ether copolymer (PFA), polytetrafluoroethylene (PTFE), polyimide, polyether imide, and polyether sulfone (PES). The release layer facilitates separation or peeling-off of toner of the toner image on the sheet P from the fixing belt 21.

The fixing belt 21 includes the elastic layer. However, the fixing belt 21 may not include the elastic layer. In this case, the fixing belt includes the base layer and the release layer as a surface layer formed on the base layer.

Inside the loop of the fixing belt 21, the planar heater 24, the holder 23, the stay 30, and the thermistor 40 are disposed

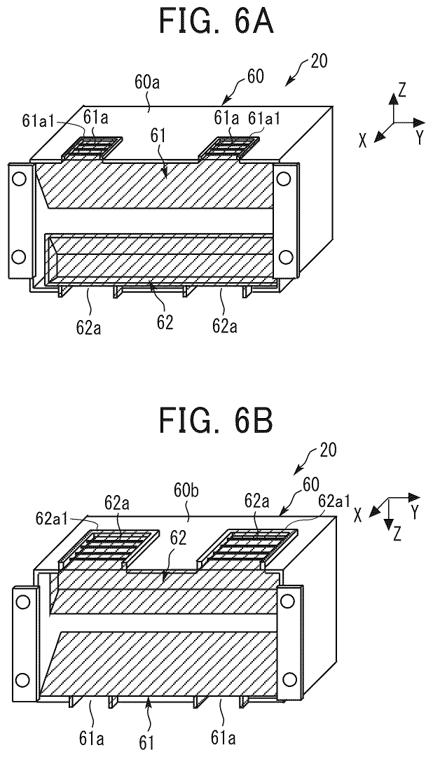

The planar heater 24 is disposed so as to extend in a width direction that is a direction perpendicular to the surface of the paper on which FIG. 3 is drawn, the lateral direction in each of FIGS. 4 and 5, and a ±y direction in FIGS. 6A to 10B each indicated by an arrow y. The planar heater 24 contacts the inner circumferential surface of the fixing belt 21. The planar heater 24 is pressed against the pressure roller 31 via the fixing belt 21 to form the fixing nip through which the sheet P is conveyed. The planar heater 24 is disposed inside the loop formed by the fixing belt 21 such that the inner circumferential surface of the fixing belt 21 slides over the planar heater 24. Pressing the planar heater 24 against the pressure roller 31 via the fixing belt 21 forms the fixing nip between the fixing belt 21 and the pressure roller 31, through which the sheet P is conveyed. As described above, the planar heater 24 functions as a nip formation pad that is a member forming the fixing nip. The planar heater 24 may include a surface layer or a sheet made of a low friction material such as PTFE on the surface of the planar heater 24 to reduce sliding friction between the fixing belt 21 and the planar heater 24.

In addition, the planar heater 24 includes a resistor pattern (in other words, a resistive heat generator) formed on a portion that is in sliding contact with the inner circumferential surface of the fixing belt 21. A power supply supplies electric power to the resistor pattern, and the resistor pattern generates heat according to the resistance of the resistor pattern to heat the fixing belt 21. As described above, the planar heater 24 also functions as a heater to heat the fixing belt 21.

The holder 23 holds the planar heater 24. The holder 23 has a recess, and the planar heater 24 is fitted into the recess to hold the planar heater 24 in the width direction.

The stay 30 holds the holder 23 holding the planar heater 24. The exterior housing frame 60 of the fixing device 20 holds both ends of the stay 30 holding the planar heater 24 and the holder 23 in the width direction via flanges 42 (see FIG. 4). As a result, the exterior housing frame 60 houses the planar heater 24.

As described above, the planar heater 24 (the resistor pattern) disposed inside the loop of the fixing belt 21 directly heats the fixing belt 21. The outer circumferential surface of the fixing belt 21 heated by the planar heater 24 heats the toner image on the sheet P.

The output of the planar heater 24 is controlled based on the temperature of the planar heater 24 detected by the thermistor 40. The thermistor 40 directly contacts the planar heater 24 (or indirectly contacts the planar heater 24 via another member). The fixing device 20 according to the present embodiment does not include a temperature sensor that directly detects the surface temperature of the fixing belt 21. A controller controls the temperature of the planar heater 24 detected by the thermistor 40 to indirectly control the surface temperature (that is a fixing temperature) of the fixing belt 21 to a desired temperature.

With reference to FIG. 5, a pair of flanges 42 guides the ends of the inner circumferential surface of the fixing belt 21 in the width direction of the fixing belt 21 such that the fixing belt 21 maintains a substantially cylindrical posture.

Specifically, the two flanges 42 are made of a heat-resistant resin material and are held by both sides of the exterior housing frame 60 in the width direction of the exterior housing frame 60 of the fixing device 20 so that each of the flanges 42 can slide and move along each of the sides of the exterior housing frame 60 in a direction forming the fixing nip. Each of the flanges 42 includes a guide 42a and a stopper. The guides 42a hold the fixing belt 21 to maintain the substantially cylindrical posture of the fixing belt 21. The stopper restricts motion or skew of the fixing belt 21 in the width direction of the fixing belt 21.

As illustrated in FIG. 4, the fixing device 20 includes pressing levers 52 of a pressing device 51. The pressing levers press the flanges 42 such that the fixing belt 21, the planar heater 24, and the holder 23 press the pressure roller 31.

The flanges 42 are disposed to support both ends of the loop of the fixing belt 21 in the width direction except for portions facing both ends of the fixing nip so that the planar heater 24 can form the fixing nip.

The inner circumferential surface of the fixing belt 21 is loosely contacted only by the planar heater 24 and the flanges 42 at respective ends of the fixing belt 21 in the width direction thereof. No other component, such as a belt guide, contacts the inner circumferential surface of the fixing belt 21 to guide the fixing belt 21 as it rotates.

The fixing device 20 includes the stay 30 that is disposed inside the loop of the fixing belt 21 so as to be in contact with the pressure roller 31 via the holder 23, the planar heater 24, and the fixing belt 21. The stay 30 reinforces the planar heater 24 forming the fixing nip (and the holder 23), enhancing the mechanical strength of the holder 23 and the planar heater 24. The stay 30 is assembled to the exterior housing frame 60 (or the holder 23) by screw fastening or other fasteners.

The stay 30 contacts the pressure roller 31 via the holder 23, the planar heater 24, and the fixing belt 21 to receive the pressure from the pressure roller and prevents a disadvantage that the pressure from the pressure roller 31 largely deforms the planar heater 24 (and the holder 23) at the fixing nip. Preferably, the stay 30 is made of metal having an increased mechanical strength, such as stainless steel or iron, to achieve the above-described function.

The holder 23 may be made of resin or metal. Preferably, the holder 23 is made of resin that has rigidity to prevent the holder 23 from bending even if the holder 23 receives pressure from the pressure roller 31, and the resin preferably has heat resistance and thermal insulation. The resin may be liquid crystal polymer (LCP), polyamide imide (PAI), polyether sulfone (PES), polyphenylene sulfide (PPS), polyether nitrile (PEN), and polyether ether ketone (PEEK). The holder 23 according to the present embodiment is made of liquid crystal polymer (LCP).

With reference to FIG. 3, the pressure roller 31 as the pressure rotator includes a cored bar 32 (serving as an axial portion) and an elastic layer 33 coating the cored bar 32. The pressure roller 31 is driven and rotated counterclockwise in FIG. 3 by a drive motor 95.

The cored bar 32 of the pressure roller 31 has a hollow structure made of metal. The elastic layer 33 of the pressure roller 31 is made of a material such as silicone rubber foam, silicone rubber, or fluororubber. A thin release layer made of PFA or PTFE may be disposed on the surface of the elastic layer 33. The pressure roller 31 is pressed against the fixing belt 21 to form a desired nip (the fixing nip) between the fixing belt 21 and the pressure roller 31. As illustrated in FIG. 4, a gear 45 is attached to the pressure roller 31 and engages a driving gear of the drive motor so that the pressure roller 31 is driven and rotated counterclockwise in FIG. 3, that is, a direction indicated by the arrow in FIG. 3. Both ends of the pressure roller 31 in the width direction are rotatably supported by the exterior housing frame 60 of the fixing device 20 through bearings, respectively.

A description is provided of a regular fixing process to fix the toner image on the sheet P, which is performed by the fixing device 20 having the construction described above.

When the controller in the image forming apparatus 100 receives a print request, the controller controls the power supply to supply the electric power to the planar heater 24 and controls the drive motor 95 to start rotating the pressure roller 31 in the direction indicated by the arrow in FIG. 3. Due to driving and rotating the pressure roller 31, friction between the pressure roller 31 and the fixing belt 21 at the fixing nip rotates the fixing belt 21 in a direction indicated by an arrow in FIG. 3.

After the fixing belt 21 rotates, the sheet P is fed from the sheet feeder 12, and the toner image is transferred onto the sheet P at the position of the transfer roller 9. As a result, the sheet P bears an unfixed image. As illustrated in FIG. 3, the sheet P bearing the unfixed toner image is conveyed in a direction indicated by an arrow Y10 while the sheet P is guided by the entrance guide plate 59 and enters the fixing nip formed between the fixing belt 21 and the pressure roller 31 pressed against the fixing belt 21.

The planar heater 24 heats the fixing belt 21. The planar heater 24 and the holder 23 are reinforced by the stay 30 and pressed against the pressure roller 31. The heat in the fixing belt 21 and the pressure between the planar heater 24 and the pressure roller 31 fix the toner image on the surface of the sheet P. After the toner image is fixed on the surface of the sheet P, the sheet P is sent out from the fixing nip and conveyed in a direction indicated by an arrow Y11 in FIG. 3.

The following describes the configuration and operation of the fixing device 20 as the characteristic removable unit in the image forming apparatus 100 according to the present embodiment in detail.

The fixing device 20 according to the present embodiment functions as the removable unit detachably attached to the body of the image forming apparatus 100 as the apparatus body. As described above with reference to FIGS. 1 and 2, the operations to detach the fixing device 20 as the removable unit from the body of the image forming apparatus 100 as the apparatus body and attach the fixing device 20 to the apparatus body are limited to maintenance operations performed by the service person such as replacing the fixing device 20 with the new one. It is not assumed that the user detaches the fixing device 20 from the apparatus body and attaches the fixing device 20 to the apparatus body. Specifically, the service person opens the cover 110 of the body of the image forming apparatus 100 to detach the fixing device 20 from the body of the image forming apparatus 100 and attach the fixing device 20 to the body of the image forming apparatus 100.

As illustrated in FIGS. 3, 6A, and 6B, the fixing device 20 according to the present embodiment as the removable unit is covered with the exterior housing frame 60 as the exterior housing made of metal such as stainless steel.

Specifically, the exterior housing frame 60 substantially covers the fixing device 20 except for an entrance portion including the entrance guide plate 59 into which the sheet P is fed and an exit portion including the fixing-side conveyance guide 61 and the pressing-side conveyance guide 62 from which the sheet P is sent out.

In addition to functioning as the exterior, the exterior housing frame 60 also functions as the housing (a structure) of the fixing device 20 as the removable unit and rotatably holds the fixing belt 21 as the fixing rotator and the pressure roller 31 as the pressure rotator as described above with reference to FIG. 4.

Making the exterior housing frame 60 serving as the exterior and the housing from metal enables the above-described fixing device 20 to reduce the size and the cost to be smaller than the size and the cost of a fixing device including a molded-plastic exterior housing.

However, since the fixing device 20 includes the heater (the planar heater 24) inside the fixing device 20, the temperature of the exterior housing frame 60 as the exterior housing made of metal is more likely to be higher than the temperature of the exterior housing made of resin. As a result, the service person grips the exterior housing frame 60 having a high temperature if the service person takes out the fixing device 20 from the body of the image forming apparatus 100 immediately after the fixing device 20 is used. The service person needs to pay attention to the burn. For example, the service person needs to wear dedicated gloves.

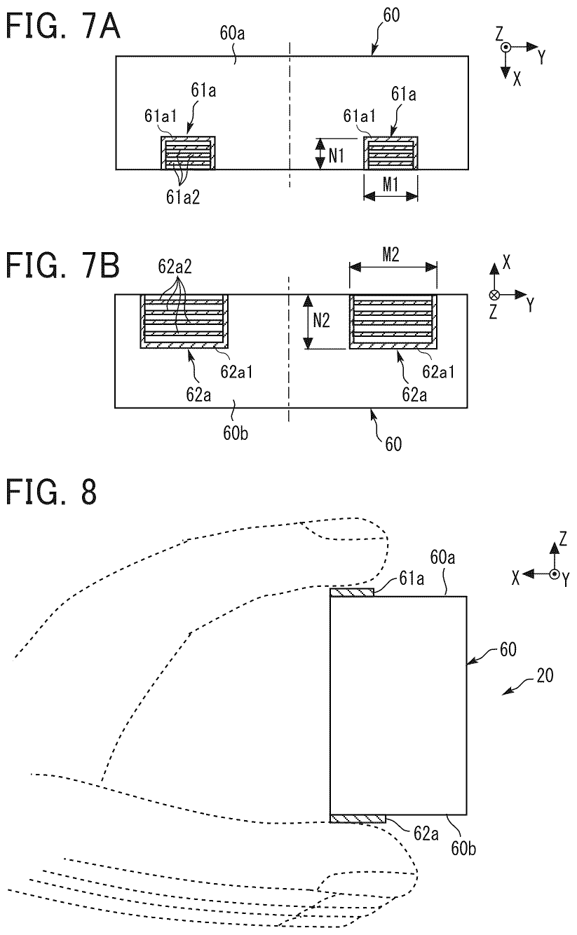

To solve the above-described issues, the fixing device 20 according to the present embodiment includes first grips 61a and second grips 62a as illustrated in FIGS. 6A to 7B. The first grips 61a and the second grips 62a are made of material having a lower thermal conductivity than the metal of the exterior housing frame 60 (the exterior housing), such as heat-resistant resin. The first grips 61a and the second grips 62a are exposed on a part of an outer face of the exterior housing of the exterior housing frame 60. In the above, the exterior housing of the exterior housing frame 60 means a portion of the exterior housing frame 60 functioning as the exterior housing.

The service person grips the first grip 61a and the second grip 62a as indicated by a broken line in FIG. 8 to detach the fixing device 20 from the body of the image forming apparatus 100 and attach the fixing device 20 to the body of the image forming apparatus 100. Since the temperatures of the first grips 61a and the second grips 62a made of resin are lower than the temperature of the exterior housing frame 60 made of metal, the above-described structure enhances operability to detach the fixing device 20 from the apparatus body and attach the fixing device 20 to the apparatus body.

As a result, the fixing device 20 can be easily attached to and detached from the body of the image forming apparatus 100 without increasing the size and cost of the fixing device 20.

The first grip 61a and the second grip 62a are made of the material having the low thermal conductivity and being less likely to be heated to a high temperature as described above and are formed on the fixing-side conveyance guide 61 and the pressure-side conveyance guide 62, respectively, which guide the sheet P fed from the fixing nip as conveyance guides.

Specifically, as illustrated in FIGS. 6A to 7B, the fixing-side conveyance guide 61 is disposed closer to the fixing belt 21 as the fixing rotator than to the pressure roller 31. In addition, the fixing-side conveyance guide 61 is disposed inside the exterior housing frame 60 (the exterior housing) not to be exposed on the exterior housing frame 60. On the other hand, the pressure-side conveyance guide 62 is disposed closer to the pressure roller 31 as the pressure rotator than to the fixing belt 21. The pressure-side conveyance guide 62 is disposed inside the exterior housing frame 60 (the exterior housing) not to be exposed on the exterior housing frame 60.

The first grip 61a and the fixing-side conveyance guide 61 are integrally molded as one component. The second grip 62a and the pressure-side conveyance guide 62 are integrally molded as one component. The first grip 61a and the second grip 62a are exposed on the outer face of the exterior housing frame 60 as the exterior housing so that the service person can grip the first grip 61a and the second grip 62a.

More specifically, the fixing device 20 as the removable unit has a substantially rectangular parallelepiped shape. In other words, the exterior housing frame 60 has the substantially rectangular parallelepiped shape extending in a longitudinal direction. The fixing device 20 is attached to and detached from the body of the image forming apparatus 100 as the apparatus body in a short-side direction of the exterior housing frame 60 that is a ±X direction in FIGS. 1 to 3, which is referred to as an attachment and detachment direction.

The fixing device 20 is moved toward the front side of the image forming apparatus 100 in a direction indicated by an arrow drawn by a dashed line in FIG. 1 that is a +X direction in FIG. 1, which is referred to as a detachment direction, to detach the fixing device 20 from the body of the image forming apparatus 100. The detachment direction is parallel to the short-side direction of the exterior housing frame 60, and the short-side direction is orthogonal to the longitudinal direction of the rectangular parallelepiped shape of the exterior housing frame 60. The first grip 61a is in a downstream end of the upper face 60a of the exterior housing frame 60 in the detachment direction, and the second grip 62a is in a downstream end of the lower face 60b of the exterior housing frame 60 in the detachment direction.

Specifically, the first grip 61a protrudes upward in a +Z direction from an upper part of the fixing-side conveyance guide 61 as the conveyance guide and is in the downstream end of the upper face 60a of the exterior housing frame 60 in the detachment direction (that is the +X direction) so that the service person puts the thumb on the first grip 61a. On the other hand, the second grip 62a protrudes downward in a −Z direction from a lower part of the pressure-side conveyance guide 62 as the conveyance guide and is in the downstream end of the lower face 60b of the exterior housing frame 60 in the detachment direction (that is the +X direction) so that the service person puts the four fingers other than the thumb on the second grip 62a to receive most of load.

In addition, the exterior housing frame 60 has notches (or holes) in the upper face 60a and the lower face 60b to expose the first grip 61a and the second grip 62a.

The fixing device 20 is designed so that the serviceperson uses both hands to hold the fixing device 20 to detach the fixing device 20 from the image forming apparatus 100 and attach the fixing device 20 to the image forming apparatus 100.

As illustrated in FIGS. 6A and 7A, two first grips 61a are on the upper part of the fixing-side conveyance guide 61 and spaced apart from a substantially center position of the exterior housing frame 60 indicated by an alternate long and short dash line in FIG. 7A by a substantially equal distance in the longitudinal direction (±Y direction). As illustrated in FIGS. 6B and 7B, two second grips 62a are on the lower part of the pressure-side conveyance guide 62 and spaced apart from a substantially center position of the exterior housing frame 60 indicated by an alternate long and short dash line in FIG. 7B by a substantially equal distance in the longitudinal direction (±Y direction). In other words, the fixing device 20 includes two grips spaced apart from a center of the exterior housing frame 60 by an equal distance in the longitudinal direction.

The above-described structure enables the serviceperson to hold the left first grip 61a and the left second grip 62a with the left hand and the right first grip 61a and the right second grip 62a with the right hand in a balanced manner to attach and detach the fixing device 20.

As illustrated in FIG. 3, multiple screws 90 fasten the fixing-side conveyance guide 61 to the upper face 60a of the exterior housing frame 60 as the exterior housing. Similarly, multiple screws 90 fasten the pressure-side conveyance guide 62 to the lower face 60b of the exterior housing frame 60 as the exterior housing. Fixing the fixing-side conveyance guide 61 and the pressure-side conveyance guide 62 to the exterior housing frame 60 that also functions as a housing as described above enhance the ease of positioning the fixing-side conveyance guide 61 and the pressure-side conveyance guide 62 to reliably exhibit the function of the fixing-side conveyance guide 61 and the pressure-side conveyance guide 62 that guide the conveyance of the sheet P.

In the above, the screws 90 fix the fixing-side conveyance guide 61 and the pressure-side conveyance guide 62 to the exterior housing frame 60, but the fixing method is not limited to this. For example, snap-on pins may be used.

With reference to FIG. 2B (and FIGS. 6A and 6B), screws 91 fasten a downstream side of the fixing device 20 in the detachment direction (in other words, a front side of the fixing device 20) to side plates of the body of the image forming apparatus 100 (in other words, housing of the body). Accordingly, the serviceperson screws the screws 91 to attach the fixing device 20 to the image forming apparatus 100 and unscrews the screws 91 to detach the fixing device 20 from the image forming apparatus 100.

With reference to FIG. 7A (and FIG. 6A), the first grip 61a includes multiple ribs 61a2 arranged at intervals in the short-side direction of the fixing device 20 that is the same as the attachment and detachment direction and the ±X direction. Each rib 61a2 extends in the longitudinal direction that is the ±Y direction. With reference to FIG. 7B (and FIG. 6B), the second grip 62a includes multiple ribs 62a2 arranged at intervals in the short-side direction and each extending in the longitudinal direction.

When the fixing-side conveyance guide 61a and the pressure-side conveyance guide 62a are formed by injection molding, the ribs 61a2 are integrally formed as a part of the first grip 61a, and the ribs 62a2 are integrally formed as a part of the second grip 62a.

The ribs 61a2 and 62a2 on the first grip 61a and the second grip 62a cause the fingers of the serviceperson gripping the first grip 61a and the second grip 62a to be less likely to slip, increase a grip force, and enhance attachment and detachment operability.

With reference to FIG. 7A (and FIG. 6A), the first grip 61a in the notch (or the hole) of the upper face 60a of the exterior housing frame 60 (as the exterior housing) includes a first edge portion 61a1 protruding upward from a portion of the first grip 61a other than the downstream side of the first grip 61a in the detachment direction (the +X direction). In other words, the first grip 61a includes the first edge portion 61a1. With reference to FIG. 7B (and FIG. 6B), the second grip 62a in the notch (or the hole) of the lower face 60b of the exterior housing frame 60 (as the exterior housing) includes a second edge portion 62a1 protruding downward from a portion of the second grip 62a other than the downstream side of the second grip 62a in the detachment direction (the +X direction). In other words, the second grip 62a includes the second edge portion 62a1.

The first edge portion 61a1 has a substantially C-shape when viewed from above and is formed on the upper grip 61a so as to protrude upward from the portion of the first grip 61a other than the downstream side of the first grip 61a. In other words, the first edge portion 61a1 surrounds the portion of the first grip 61a. Similarly, the second edge portion 62a1 has a substantially C-shape when viewed from below and is formed on the lower grip 62a so as to protrude downward from the portion of the second grip 62a other than the downstream side of the second grip 62a. In other words, the second edge portion 62a1 surrounds the portion of the second grip 62a.

The first edge portion 61a1 and the second edge portion 62a1 that are formed as described above enable the serviceperson to easily visually recognize the first grip 61a and the second grip 62a. In addition, the first edge portion 61a1 and the second edge portion 62a1 enable the serviceperson to easily grip the center of each of the first grip 61a and the second grip 62a (portions surrounded by the first edge portion 61a1 and the second edge portion 62a2). As a result, the first edge portions 61a1 and the second edge portions 62a1 enhance the operability of the serviceperson, the operability to detach the fixing device 20 from the image forming apparatus 100 and attach the fixing device 20 to the image forming apparatus 100.

In order to distinguish the first grips 61a and the second grips 62a from other parts that are in upper face 60a and the lower face 60b and obtain the same effect as described above, the first grips 61a and the second grips 62a may be colored, or a decal may be attached to the first grips 61a and the second grips 62a.

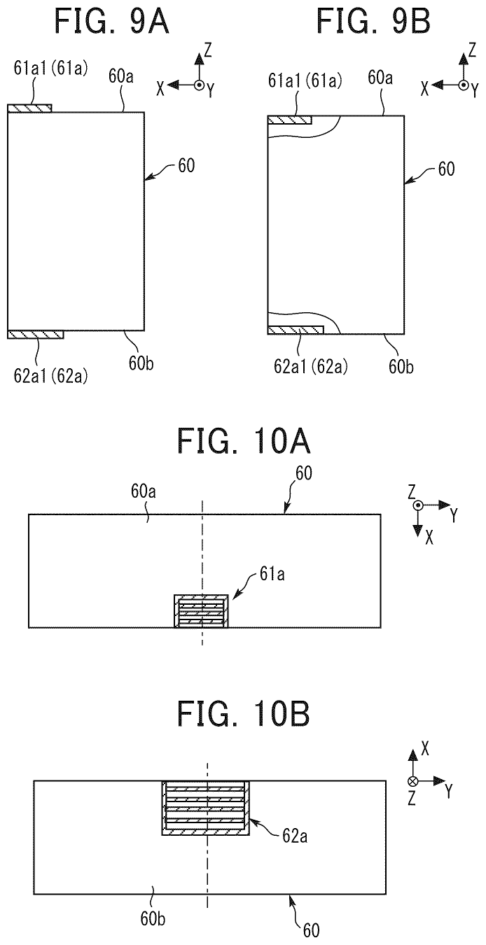

With reference to FIG. 9A, the first edge portion 61a1 according to the present embodiment penetrates the upper face 60a of the exterior housing frame 60 as the exterior housing and protrudes upward (in the +Z direction) from the portion of the first grip 61a, and the second edge portion 62a1 penetrates the lower face 60b of the exterior housing frame 60 and protrudes downward (in the −Z direction) from the portion of the second grip 62a.

In contrast, as illustrated in FIG. 9B, the first edge portion 61a1 and the second edge portion 62a1 may be formed so as not to protrude upward (in the +Z direction) from the upper face 60a of the exterior housing frame 60 as the exterior housing and not to protrude downward (in the −Z direction) from the lower face 60b of the exterior housing frame 60. The first edge portion 61a1 and the second edge portion 62a1 that do not protrude from the exterior housing frame 60 in the Z direction as described above can reduce the size of the fixing device 20 in the Z direction.

With reference to FIG. 7A, the fixing device 20 as the removable unit according to the present embodiment has a longitudinal length M1 of the first grip 61a disposed in the notch (or the hole) of the upper face 60a of the exterior housing frame 60 as the exterior housing. With reference to FIG. 7B, the fixing device 20 as the removable unit according to the present embodiment has a longitudinal length M2 of the second grip 62a disposed in the notch (or the hole) of the lower face 60b of the exterior housing frame 60 as the exterior housing. As illustrated in FIGS. 7A and 7B, the length M2 is longer than the length M1 (M1<M2).

In addition, the grip 61a disposed in the notch (or the hole) of the upper face 60a of the exterior housing frame 60 has a length N1 in the short-side direction. The second grip 62a disposed in the notch (or the hole) of the lower face 60b of the exterior housing frame 60 as the exterior housing has a length N2 in the short-side direction. As illustrated in FIGS. 7A and 7B, the length N2 is longer than the length N1 (N1<N2).

As described above with reference to FIG. 8, this is because the size of the upper first grip 61a is designed for the serviceperson to put the thumb on the first grip 61a, whereas the size of the lower second grip 62a is designed for the serviceperson to put four fingers other than the thumb on the second grip 62a to receive most of the load of the fixing device 20.

The thickness of the first grip 61a in the notch (or the hole) of the upper face 60a of the exterior housing frame 60 (the exterior housing) may be designed to be larger than the thickness of the second grip 62a in the notch (or the hole) of the lower face 60b of the exterior housing frame 60.

Alternatively, the thermal conductivity of the first grip 61a in the notch (or the hole) of the upper face 60a of the exterior housing frame 60 (the exterior housing) may be designed to be lower than the thermal conductivity of the second grip 62a in the notch (or the hole) of the lower face 60b of the exterior housing frame 60. Changing the resin material of the fixing-side conveyance guide 61 (the first grip 61a) from the resin material of the pressure-side conveyance guide 62 (the second grip 62a) can change the thermal conductivity of the first grip 61a from the thermal conductivity of the second grip 62a.

Since the fixing-side conveyance guide 61 including the first grip 61a is closer to the fixing belt 21 directly heated by the planar heater 24 than the pressure-side conveyance guide 62 including the second grip 62a, the temperature of the first grip 61a tends to be higher than the temperature of the second grip 62a. The above structures prevent the temperature of the first grip 61a from becoming higher than the temperature of the second grip 62a.

With reference to FIG. 1, the image forming apparatus 100 according to the present embodiment includes a fan 120 as an airflow generator to generate airflow above the fixing device 20.

The image forming apparatus 100 has an intake in the front side of the image forming apparatus 100 (+Y direction) above the fixing device 20 and a vent in the back side of the image forming apparatus 100 (−Y direction) above the fixing device 20. The fan 120 is disposed in the vent or the intake. The above-described structure takes air from the outside of the image forming apparatus 100 through the intake and discharges the air to the outside through the vent to form the airflow above the fixing device 20. The fixing device 20 generates hot air, and the hot air moves upward from the fixing device 20. The airflow formed by the fan 120 discharges the hot air to the outside of the image forming apparatus 100 and prevents the hot air from staying in a space above the fixing device 20. The above-described structure enables the serviceperson to easily take out the fixing device 20 immediately after use from the body of the image forming apparatus 100.

A modification is described below.

As illustrated in FIGS. 10A and 10B, the fixing device 20 according to the modification is different from the fixing device 20 illustrated in FIGS. 7A and 7B in that the first grip 61a and the second grip 62a are formed at substantially the center position in the longitudinal direction (±Y direction).

The fixing device 20 configured as described above is smaller than the fixing device illustrated in FIGS. 7A and 7B. Particularly, the size of the fixing device 20 in the present modification in the ±Y direction is smaller than that illustrated in FIGS. 7A and 7B. The fixing device 20 according to the present modification is designed so that the serviceperson uses one hand to hold the fixing device 20 to detach the fixing device 20 from the image forming apparatus 100 and attach the fixing device 20 to the image forming apparatus 100.

The above-described structure enables the serviceperson to hold the first grip 61a and the second grip 62a disposed at the center position with one hand in a balanced manner to attach and detach the fixing device 20.

As described above, the fixing device 20 according to the present embodiment serves as the removable unit detachably attached to the image forming apparatus 100 as the apparatus body and includes the exterior housing frame 60 as the exterior housing made of metal. In addition, the fixing device 20 includes the first grip 61a and the second grip 62a made of the material having a lower thermal conductivity than that of the material of the exterior housing frame 60, and the first grip 61a and the second grip 62a are exposed on a part of the outer face of the exterior housing frame 60.

As a result, the fixing device 20 can be easily attached to and detached from the body of the image forming apparatus 100 without increasing the size and cost of the fixing device 20.

The above-described embodiments and modification are applied to the fixing device 20 including the fixing belt 21 as the fixing rotator, the pressure roller 31 as the pressure rotator, and the planar heater 24 as the heater. However, the fixing device to which the present disclosure is applied is not limited to this. For example, the present disclosure may be applied to the fixing device including another type of heater or electromagnetic induction coil as the heater, the fixing device including a fixing roller or a fixing belt stretched around multiple rollers as the fixing rotator, or the fixing device including a pressure belt as the pressure rotator.

The above-described embodiments and modification are applied to the fixing device 20 as the removable unit. However, the removable unit to which the present disclosure is applied is not limited to this. For example, the present disclosure may be applied to the process cartridge 6 or the exposure device 7 that serve as the removable unit.

The above-described embodiments and modification are applied to the removable unit (the fixing device 20) detachably attached to the body of the image forming apparatus 100 as the apparatus body. However, the apparatus body is not limited to this. The removable unit to which the present disclosure is applied may be attached to any one of various types of apparatus bodies. The present disclosure may be applied to the various types of apparatuses or devices.

The above-described configurations also provide similar effects to those of the above-described embodiment and the modifications.

Note that embodiments of the present disclosure are not limited to the above-described embodiments, and it is apparent that the above-described embodiments can be appropriately modified within the scope of the technical idea of the present disclosure in addition to what is suggested in the above-described embodiments. Further, features of components of the embodiments, such as the number, the position, and the shape are not limited the embodiments and thus may be preferably set.

In the present description, the term “sheet” is defined as any sheet-like recording medium including all conveyed objects, such as typical paper, coated paper, label paper, overhead projector (OHP) transparency, or a film sheet.

Aspects of the present disclosure are, for example, as follows.

### FIRST ASPECT

In a first aspect, a removable unit detachably attached to an apparatus body includes an exterior housing made of metal and a grip made of a material having a lower thermal conductivity than the metal, and the grip is exposed on a part of an outer face of the exterior housing.

### SECOND ASPECT

In a second aspect, the removable unit according to the first aspect includes a heater, and the grip is made of resin. In addition, the exterior housing functions as a housing of the removable unit.

### THIRD ASPECT

In a third aspect, the removable unit according to the first aspect or the second aspect has a substantially rectangular parallelepiped shape, is attached to and detached from the apparatus body in a short-side direction as an attachment and detachment direction, and includes grips including the grip. One of the grips is in a downstream portion of an upper face of the exterior housing in a detachment direction, and another one of the grips is in a downstream portion of a lower face of the exterior housing in the detachment direction.

### FOURTH ASPECT

In a fourth aspect, two of the grips in the removable unit according to the third aspect are spaced apart from a center of the exterior housing by an equal distance in a longitudinal direction of the exterior housing.

### FIFTH ASPECT

In a fifth aspect, the removable unit according to the third aspect includes the grip at a center of the exterior housing in a longitudinal direction of the exterior housing.

### SIXTH ASPECT

In a sixth aspect, the grips in the removable unit according to any one of the first to third aspects includes multiple ribs arranged at intervals in the short-side direction, and each of the multiple ribs extends in a longitudinal direction of the exterior housing.

### SEVENTH ASPECT

In a seventh aspect, the removable unit according to any one of the third to sixth aspects includes an edge portion protruding upward from a portion of the one of the grips in the upper face of the exterior housing, the portion other than a downstream side of the one of the grips in the detachment direction and another edge portion protruding downward from a portion of said another one of the grips in the lower face of the exterior housing, the portion other than a downstream side of said another one of the grips in the detachment direction.

### EIGHTH ASPECT

In an eighth aspect, the removable unit according to the seventh aspect includes the edge portion protruding upward from the upper face and said another edge portion protruding downward from the lower face.

### NINTH ASPECT

In a ninth aspect, the removable unit according to the seventh aspect includes the edge portion not protruding upward from the upper face and said another edge portion not protruding downward from the lower face.

### TENTH ASPECT

In a tenth aspect, the removable unit according to any one of the third to ninth aspects has the following feature. In the longitudinal direction, a length of said another one of the grips in the lower face of the exterior housing is longer than a length of the one of the grips in the upper face of the exterior housing.

### ELEVENTH ASPECT

In an eleventh aspect, the removable unit according to nay one of the third to tenth aspects has the following feature. In the short-side direction, a length of said another one of the grips in the lower face of the exterior housing is longer than a length of the one of the grips in the upper face of the exterior housing.

### TWELFTH ASPECT

In a twelfth aspect, the removable unit according to any one of the third to eleventh aspects has the following feature. A thickness of the one of the grips in the upper face of the exterior housing is larger than a thickness of said another one of the grips in the lower face of the exterior housing.

### THIRTEENTH ASPECT

In a thirteenth aspect, the removable unit according to any one of the third to twelfth aspects has the following feature. A thermal conductivity of a material of the one of the grips in the upper face of the exterior housing is smaller than a thermal conductivity of a material of said another one of the grips in the lower face of the exterior housing.

### FOURTEENTH ASPECT

In a fourteenth aspect, a fixing device is detachably attached to a body of an image forming apparatus as the apparatus body and serves as the removable unit according to any one of the first to thirteenth aspects. The fixing device includes a heater, a fixing rotator heated by the heater, and a pressure rotator pressed against the fixing rotator to form a nip through which a sheet is conveyed.

### FIFTEENTH ASPECT

In a fifteenth aspect, the fixing device according to the fourteenth aspect further includes a fixing-side conveyance guide disposed between the fixing rotator and the exterior housing to guide the sheet sent out from the nip, a pressure-side conveyance guide disposed between the pressure rotator and the exterior housing to guide the sheet sent out from the nip, and grips including the grip. The grips includes a grip formed integrally with the fixing-side conveyance guide and exposed on a part of the outer face of the exterior housing and a grip formed integrally with the pressure-side conveyance guide and exposed from a part of the outer face of the exterior housing.

### SIXTEENTH ASPECT

In a sixteenth aspect, the fixing device according to the fifteenth aspect further includes screws. The fixing-side conveyance guide is fastened to the upper face of the exterior housing by the screw. The pressure-side conveyance guide is fastened to the lower face of the exterior housing by the screw.

### SEVENTEENTH ASPECT

In a seventeenth aspect, an image forming apparatus includes the fixing device according to any one of the fourteenth to sixteenth aspects.

### EIGHTEENTH ASPECT

In an eighteenth aspect, the image forming apparatus according to the seventeenth aspect includes an airflow generator to generate airflow above the fixing device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A removable unit detachably attached to an apparatus body, the removable unit comprising:
a heater;
an exterior housing made of metal, the exterior housing housing the heater; and
a grip made of a material having a lower thermal conductivity than the metal,
the grip exposed on a part of an outer face of the exterior housing.

2. The removable unit according to claim 1, further comprising
a conveyance guide in the exterior housing, the conveyance guide to guide a sheet passing through the removable unit,
wherein the conveyance guide includes the grip made of resin.

3. The removable unit according to claim 2, further comprising
grips including the grip,
wherein the removable unit is detached from the apparatus body in a detachment direction,
the exterior housing has a rectangular parallelepiped shape extending in a longitudinal direction,
the longitudinal direction is orthogonal to a short-side direction parallel to the detachment direction,
the exterior housing has:
an upper face; and
a lower face, and
the grips include:
a first grip in a downstream end of the upper face in the detachment direction; and
a second grip in a downstream end of the lower face in the detachment direction.

4. The removable unit according to claim 3,
wherein two of the grips are spaced apart, by an equal distance, from a center of the exterior housing in the longitudinal direction.

5. The removable unit according to claim 3,
wherein the first grip is disposed at a center of the upper face in the longitudinal direction, and
the second grip is disposed at a center of the lower face in the longitudinal direction.

6. The removable unit according to claim 3,
wherein each of the grips includes multiple ribs arranged at intervals in the short-side direction, and
each of the multiple ribs extends in the longitudinal direction.

7. The removable unit according to claim 3,
wherein the first grip includes a first edge portion surrounding a portion of the first grip and protruding upward from the portion of the first grip,
the second grip includes a second edge portion surrounding a portion of the second grip and protruding downward from the portion of the second grip.

8. The removable unit according to claim 7,
wherein the first edge portion penetrates the upper face and protrudes upward from the upper face, and
the second edge portion penetrates the lower face and protrudes downward from the lower face.

9. The removable unit according to claim 7,
wherein the first edge portion does not protrude upward from the upper face, and
the second edge portion does not protrude downward from the lower face.

10. The removable unit according to claim 3,
wherein a length of the second grip is longer than a length of the first grip in the longitudinal direction.

11. The removable unit according to claim 3,
wherein a length of the second grip is longer than a length of the first grip in the short-side direction.

12. The removable unit according to claim 3,
wherein a thickness of the first grip is larger than a thickness of the second grip.

13. The removable unit according to claim 3,
wherein a thermal conductivity of a material of the first grip is smaller than a thermal conductivity of a material of the second grip.

14. A fixing device detachably attached to a body of an image forming apparatus, comprising:
a heater;
a fixing rotator heated by the heater;
a pressure rotator pressed against the fixing rotator to form a nip through which a sheet is conveyed;
an exterior housing made of metal, the exterior housing housing the heater; and
a grip made of a material having a lower thermal conductivity than the metal,
the grip exposed on a part of an outer face of the exterior housing.

15. The fixing device according to claim 14, further comprising:
a fixing-side conveyance guide disposed between the fixing rotator and the exterior to guide the sheet sent out from the nip;
a pressure-side conveyance guide disposed between the pressure rotator and the exterior to guide the sheet sent out from the nip; and
grips including the grip, the grips including:
a first grip formed integrally with the fixing-side conveyance guide and exposed on a part of the outer face of the exterior; and
a second grip formed integrally with the pressure-side conveyance guide and exposed on a part of the outer face of the exterior.

16. The fixing device according to claim 15, further comprising:
a screw to fasten the fixing-side conveyance guide to an upper face of the exterior; and
another screw to fasten the pressure-side conveyance guide to a lower face of the exterior.

17. An image forming apparatus comprising:
a body; and
the fixing device according to claim 14 attached to the body.

18. The image forming apparatus according to claim 17, further comprising
a fan generating an airflow in a space above the fixing device.

19. A removable unit detachably attached to an apparatus body, the removable unit comprising:
a heating means for heating a medium;
an exterior housing means made of metal for housing the heating means, the exterior housing means for covering an outer face of the removable unit; and
a gripping means made of a material having a lower thermal conductivity than the metal, the gripping means exposed on a part of an outer face of the exterior housing means.
